(19) United States
(12) Patent Application Publication
(10) Pub. No.: US 2013/0176943 A1
(43) Pub. Date: Jul. 11, 2013

(54) System and Method for Distributed Mobility Management

(71) Applicant: FutureWei Technologies, Inc., Plano, TX (US)

(72) Inventor: Hinghung Anthony Chan, Plano, TX (US)

(73) Assignee: FUTUREWEI TECHNOLOGIES, INC., Plano, TX (US)

(21) Appl. No.: 13/734,784

(22) Filed: Jan. 4, 2013

Related U.S. Application Data
(60) Provisional application No. 61/584,031, filed on Jan. 6, 2012.
(60) Provisional application No. 61/584,044, filed on Jan. 6, 2012.

(51) Int. Cl. H04W 8/02

(52) U.S. Cl. CPC H04W 8/02
USPC 370/328

(57) ABSTRACT

A method for operating a network device includes receiving a packet addressed to a first mobile node at a first initial home address when the first mobile node is outside a home network, and accessing a location database to determine a current network for the first mobile node. The method also includes routing the packet to the first mobile node in the current network.

This application claims the benefit of U.S. Provisional Application No. 61/584,031, filed on Jan. 6, 2012, entitled “Systems and Methods for Distributed Mobility Management Mobility,” and U.S. Provisional Application No. 61/584,044, filed on Jan. 6, 2012, entitled “Systems and Methods for Generalized Distributed and Dynamic Mobility Management,” which applications are hereby incorporated herein by reference.

### TECHNICAL FIELD

The present disclosure relates generally to digital communications, and more particularly to a system and method for distributed mobility management.

### BACKGROUND

In mobility management protocols, such as Mobile Internet Protocol (mobile IP), a mobile node (MN) obtains a home address (HoA) from its home network and a care-of-address (CoA) when it is attached to a visiting network. A mobility anchor (MA), also known as a home agent (HA) in the home network intercepts the packets addressed to HoA coming from a correspondent node (CN). It then forwards the packet to the CoA.

### SUMMARY OF THE DISCLOSURE

Example embodiments of the present disclosure which provide a system and method for distributed mobility management.

In accordance with an example embodiment of the present disclosure, a method for operating a network device is provided. The method includes receiving, by the network device, a packet addressed to a first mobile node at a first initial home address when the first mobile node is outside a home network, and accessing, by the network device, a location database to determine a current network for the first mobile node. The method also includes routing, by the network device, the packet to the first mobile node in the current network.

In accordance with another example embodiment of the present disclosure, a method for routing a packet from a first device to a second device is provided. The method includes determining, by a first mobility router of the first device, a first address of a second mobility router of the second device. The method also includes setting up, by the first mobility router, a mechanism for distributed routing with the second mobility router in accordance with the first address of the second mobility router.

In accordance with another example embodiment of the present disclosure, a network device is provided. The network device includes a receiver, and a processor operatively coupled to the receiver. The receiver receives a packet addressed to a first mobile node at a first initial home address when the first mobile node is outside a home network. The processor accesses a location database to determine a current network for the first mobile node, and routes the packet to the first mobile node in the current network.

In accordance with another example embodiment of the present disclosure, a first mobility router is provided. The first mobility router includes a processor. The processor determines a first address of a second mobility router of a second device, and sets up a mechanism for distributed routing with the second mobility router in accordance with the first address of the second mobility router.

One advantage of an embodiment is that short or optimal routes between CNs and MNs may be maintained as the MN changes networks due to mobility. The short routes help to improve communications performance by reducing latency and communications system overhead.

A further advantage of an embodiment is that a distributed mobility management technique is presented. A distributed implementation helps to reduce communications overhead involved in mobility management as well as computational requirements at any one centralized management entity.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system, highlighting a technique for routing packets to a mobile node according to example embodiments described herein;

FIG. 2a illustrates an example first DMF according to example embodiments described herein;

FIG. 2b illustrates an example second DMF according to example embodiments described herein;

FIG. 3 illustrates an example flow diagram of operations 300 in a DMF according to example embodiments described herein;

FIG. 4a illustrates an example logical view of a communications system according to example embodiments described herein;

FIG. 4b illustrates an example logical view of a communications system 450 where network based mobility management is used according to example embodiments described herein;

FIG. 5 illustrates an example logical view of a communications system with decomposition of a route according to example embodiments described herein;

FIG. 6a illustrates an example flow diagram of operations 600 in RS1-1 at an MR according to example embodiments described herein;

FIG. 6b illustrates an example flow diagram of operations 650 in RS 1-2 at an MR according to example embodiments described herein;

FIG. 7a illustrates an example flow diagram of operations 700 in RS2-1 at an MR according to example embodiments described herein;

FIG. 7b illustrates an example flow diagram of operations 750 in RS2-2 at an MR according to example embodiments described herein;

FIG. 8 illustrates an example flow diagram of operations 800 in RS3-1 at an MR according to example embodiments described herein;

FIG. 9 illustrates an example flow diagram of operations 900 in communications between two networks of a communications system according to example embodiments described herein;

FIG. 10 illustrates an example flow diagram of operations 1000 in communications between two networks of a communications system in accordance with a first example embodiment described herein;

FIG. 11 illustrates an example flow diagram of operations 1100 in communications between two networks of a communications system in accordance with a second example embodiment described herein;

FIG. 12 illustrates an example flow diagram of operations 1200 in communications between two networks of a communications system in accordance with a third example embodiment described herein;

FIG. 13 illustrates an example flow diagram of operations 1300 in communications between two networks of a communications system in accordance with a fourth example embodiment described herein;

FIG. 14 illustrates an example flow diagram of operations 1400 in communications between two networks of a communications system in accordance with a fifth example embodiment described herein;

FIG. 15 illustrates an example flow diagram of operations 1500 in communications between two networks of a communications system in accordance with a sixth example embodiment described herein;

FIG. 16 illustrates an example first communications device according to example embodiments described herein; and

FIG. 17 illustrates an example second communications device according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

The present invention will be described with respect to example embodiments in a specific context, namely a communications system that uses a Mobile IP communications protocol. The invention may also be applied, however, to other communications systems that allow mobile nodes to retain a permanent address as the mobile nodes move between networks.

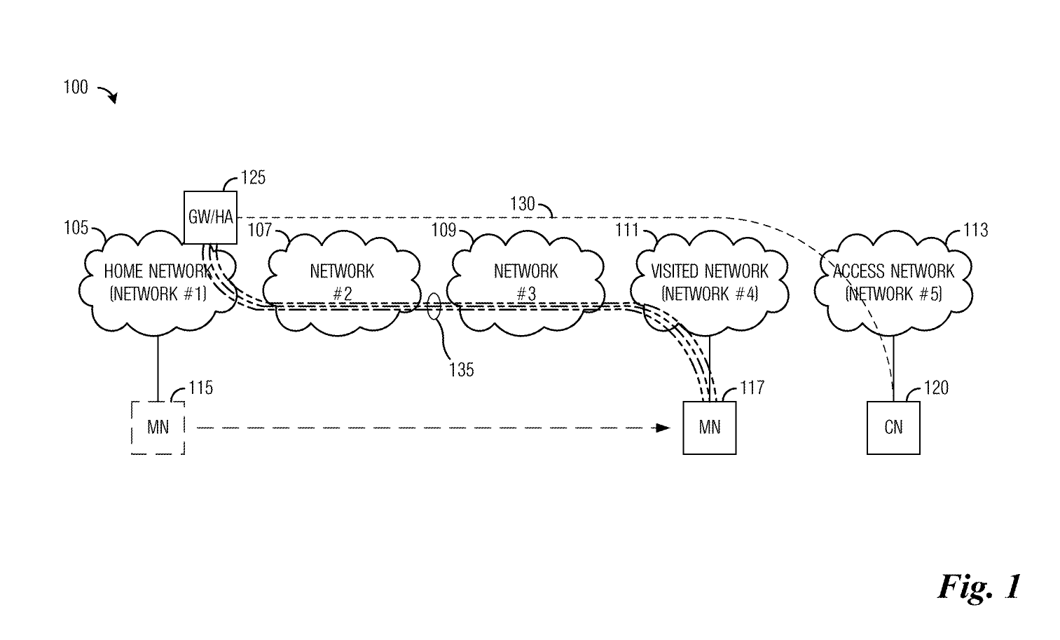

FIG. 1 illustrates a communications system 100, highlighting a technique for routing packets to a mobile node. Communications system 100 makes use of Mobile IP and includes a number of networks, including network #1 105, network #2 107, network #3 109, network #4 111, and network #5 113. Communications system 100 also includes a MN 115, which initially registered with network #1 105, making network #1 105 the HN for MN 115. Communications system 100 also includes a CN 120, accessing communications system 100 through network #5 113.

While it is understood that communications systems may employ multiple networks capable of communicating with a number of MNs and CNs, only five networks, one MN, and one CN are illustrated for simplicity.

Through its registration with network #1 105, MN 115 is assigned a home address (HoA). A mobility anchor, also commonly referred to as an HA, may be used to maintain information about the mobility of MN 115. The combination HA and GW is shown in FIG. 1 as GW/HA 125. GW/HA 125 operates in the HN of MN 115, i.e., network #1 105, and intercepts packets addressed to the HoA from a source node, such as CN 120, and forwards the packets to the CoA.

If MN 115, through its mobility, changes its network, from its current network (i.e., network #1 105) to a new network (network #4 111, for example), MN 115 may be assigned a care of address (CoA) by an HA in its new network. It is noted that MN 115, while operating in its new network, is shown in FIG. 1 as MN 117 to prevent confusion. However, packets intended for MN 117 (formerly MN 115) may still be addressed to the HoA of MN 117 and are therefore routed to GW/HA 125 via route 130, which may then tunnel (through tunnel 135) the packets to the new network (network #4 111, for example) of MN 117 and eventually to MN 117.

As shown in FIG. 1, a path taken by packets from CN 120 to MN 117 may be less than optimal. Instead of going directly from network #5 113 to network #4 111 and then to MN 117, packets must go through a number of networks to get to GW/HA 125 of network #1 105 and then to network #4 111 and eventually to MN 117.

According to an example embodiment, it may be possible to provide distributed mobility management by having a distributed mobility function (DMF) in each network of a communications system. The DMF may be used to allocate a HoA to a MN when the MN initially attaches to the communications system, internetwork location management that manages and keeps track of a MN as the MN moves, and mobility routing that intercepts packets addressed to a MN's HoA or originating from the MN's HoA and forward the packets to their intended destination.

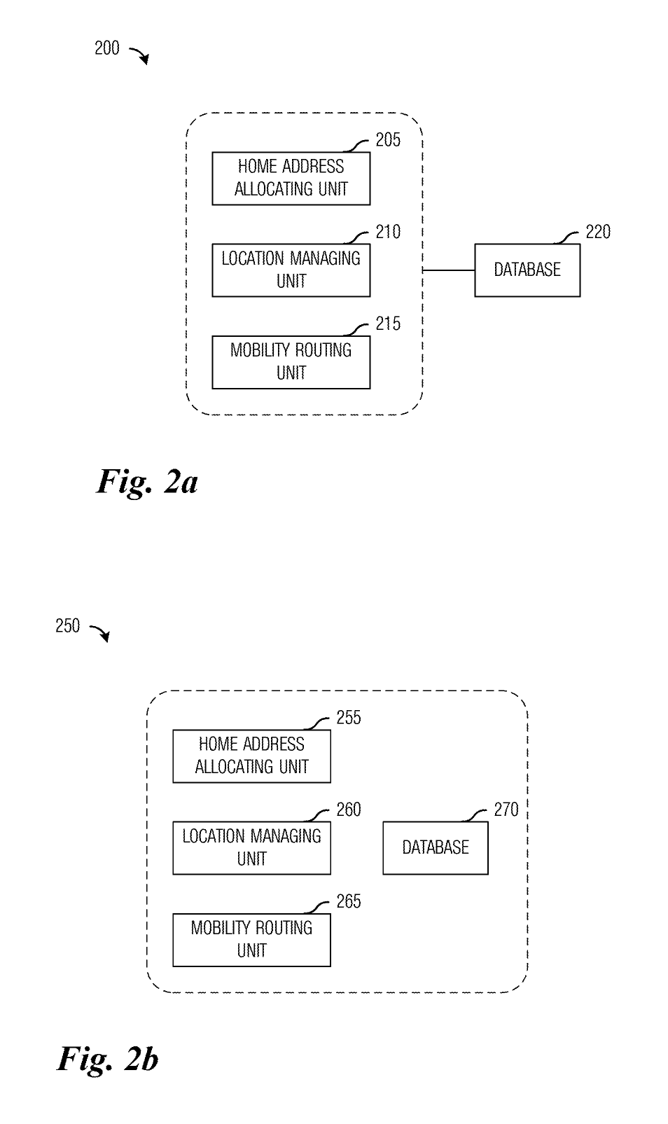

FIG. 2a illustrates a first DMF 200. DMF 200 may be a first example embodiment of a DMF used to provide distributed mobility management in a communications system. DMF 200 may be located in each network of the communications system. DMF 200 may include a home address allocating unit 205 used to allocate a HoA to a MN when the MN initially attaches to the network of the communications system where the DMF 200 is located. DMF 200 may also include a location managing unit 210 that manages and keeps track of a MN as the MN moves, potentially changing networks and/or exiting the communications system all together. Location managing unit 210 may also establish an entry for a MN as it initially attaches to the network of the communications system or when it moves away from the network. DMF 200 may also include a mobility routing unit 215 intercepts packets addressed to a MN's HoA or originating from the MN's HoA and forward the packets to their intended destination.

DMF 200 may be coupled to a database 220, which may be implemented as a distributed database, and used to store location information regarding the MN. As an example, when the MN initially attaches to the network of the communications system, location managing unit 210 may establish an entry for the MN in database 220, which may be updated by location managing unit 210 if the MN should change networks due to mobility. It is noted that another DMF in another network of the communications system may also establish entries for the MN when (and if) the MN moves into the network associated with the other DMF. Alternatively, database 220 may also be implemented as a centralized database where the DMFs of the communications system store location information for their respective MNs. Alternatively, database 220 may be implemented as a combination of both distributed and centralized databases.

FIG. 2b illustrates a second DMF 250. DMF 250 may be a second example embodiment of a DMF used to provide distributed mobility management in a communications system. DMF 250 may be located in each network of the communications system. DMF 250 may include a home address allocating unit 255 used to allocate a HoA to a MN when the MN initially attaches to the network of the communications system where the DMF 250 is located. DMF 250 may also include a location managing unit 260 that manages and keeps track of a MN as the MN moves, potentially changing networks and/or exiting the communications system all together. Location managing unit 260 may also establish an entry for a MN as it initially attaches to the network of the communications system. DMF 250 may also include a mobility routing unit 265 intercepts packets addressed to a MN's HoA or originating from the MN's HoA and forward the packets to their intended destination.

DMF 250 may include a database 270, which may be implemented as a distributed database, and used to store location information regarding the MN. As an example, when the MN initially attaches to the network of the communications system, location managing unit 260 may establish an entry for the MN in database 270, which may be updated by location managing unit 260 if the MN should change networks due to mobility. It is noted that another DMF in another network of the communications system may also establish entries for the MN when (and if) the MN moves into the network associated with the other DMF. Alternatively, database 270 may be implemented as a combination of both distributed and centralized databases, meaning that there is a portion of database 270 that is located at a centralized database.

DMF 200 and/or DMF 250 may be implemented in a gateway router of a network, an access router of a network, a separate standalone entity in a network, embedded in a communications controller (such as an base station, an evolved NodeB, NodeB, switch, mobility management entity (MME), and the like), and the like. Database 220 and/or database 270 may be implemented as a storage device with a controller that is a part of or coupled to DMF 200 and/or DMF 250. Database 220 and/or database 270 may be a combination of a distributed database and a centralized database.

It is noted that mobility routing units 215 and 265 implement a mobility routing (MR) function that is distributed in multiple locations (e.g., in each DMF located at each network of the communications system) so that routing of packets may be optimized. While in a control plane, location management (LM) as implemented by location managing units 210 and 260 may provide a distributed database of mappings between HoA and care-of-address (CoA). The distributed database (e.g., database 220 and 270) may have multiple servers, which may individually co-located with home address allocating units 205 and 255 in each DMF of each network.

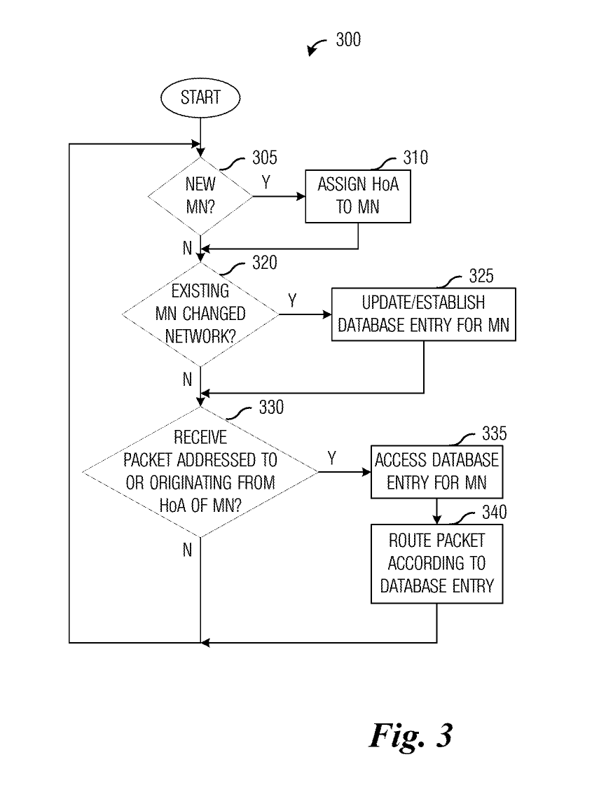

FIG. 3 illustrates a flow diagram of operations 300 in a DMF. Operations 300 may be indicative of operations occurring in a DMF, such as DMF 200 and DMF 250, as the DMF performs distributed mobility management.

Operations 300 may include the DMF determining if it is associating with a new MN (block 305). If the DMF is associating with the new MN, the DMF may assign a HoA to the new MN (block 310). A home address allocating unit of the DMF may assign the HoA to the new MN. As an example, the HoA for the new MN may belong to a range of addresses assigned to the DMF. The DMF may also establish an entry in a location database for the new MN. Although this may not be necessary unless the new MN is expected to move away from its home network. A location managing unit of the DMF may establish an entry in the location database for the new MN, which may include information such as the HoA for the new MN, a home network for the new MN (i.e., the network associated with the DMF), identity information of the new MN, information about a user of the new MN, and the like.

The DMF may also determine if a MN has changed network (block 320). In general, the MN may change network by performing a handover between a first network and a second network, with the first network being the MN's old network and the second network being the MN's new network. If the MN has changed network, the DMF may update the MN's entry in the location database. As an example, if the DMF is associated with the first network, then the DMF may update the MN's entry in its location database with information about the second network. While if the DMF is associated with the second network, then the DMF may establish an entry for the MN in its location database and include information such as the HoA for the MN, the home network for the MN (i.e., the network where the MN associated), identity information of the MN, information about a user of the MN, and the like.

The DMF may determine if it has received a packet addressed to a HoA of a MN or originating from the HoA of the MN (block 330). If the DMF has received such a packet, the DMF may access the location database to determine the MN's network (block 335). With the MN's network from the location database, the DMF may route the packet to its destination (block 340).

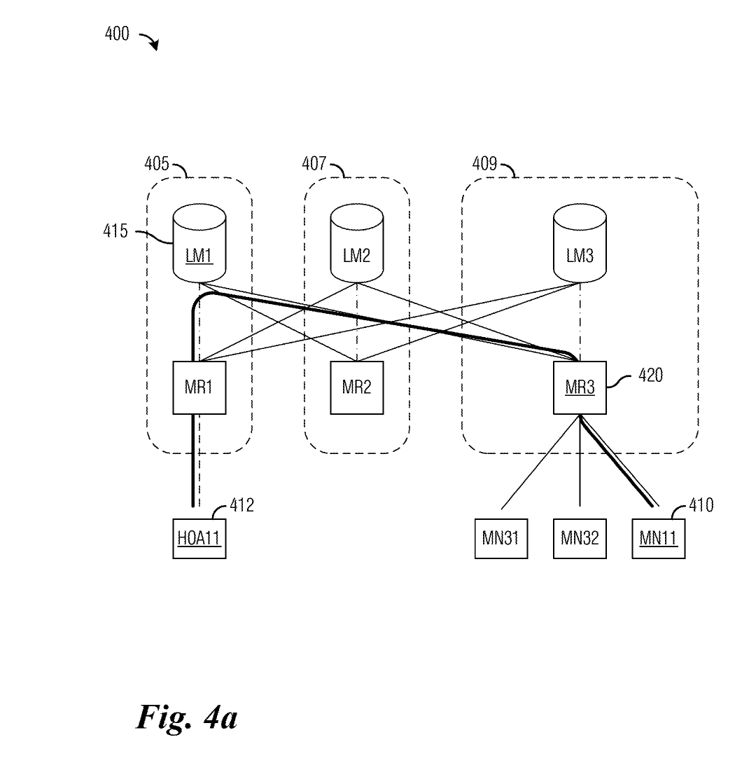

FIG. 4a illustrates a logical view of a communications system 400. Communications system 400 includes three networks that are represented by their respective DMFs: DMF 405, DMF 407, and DMF 409. Each DMF includes a LM (a logical representation of a location managing unit) and a MR (a logical representation of a mobility routing unit).

As shown in FIG. 4a, a MN 410 (shown in FIG. 4a as MN11) initially attaches to a network associated with DMF 405 (i.e., its home network) and is assigned a HoA 412 (shown in FIG. 4a as HOA11). MN 410 (MN11) moves to a network associated with DMF 409. Although it has changed networks, HoA 412 remains the HoA of MN 410 (MN11). In general, MN 410 (MN11) may make use of HoA 412 for sessions that already started when MN 410 (MN11) is attached to its home network and that require continuity after handover. While MN 410 (MN11) is attached to its home network, no distributed mobility management is needed and an entry for MN 410 (MN11) may not be added to a location database.

After MN 410 (MN11) performs a handover to the network associated with DMF 409, LM 415 may establish an entry for MN 410 (MN11) in the location database. As an example, LM 415 may include a mapping of HoA 412 to MR 420. In other words, the mapping associated with MN 410 (MN11) may point to the network associated with DMF 409 and the network associated with DMF 409 (e.g., MR 420) may keep track of how to reach MN 410 (MN11). The use of a hierarchical mapping may help to avoid frequent update signaling to LM 415 as MN 410 (MN11) performs intra-network handovers within the network associated with DMF 409, for example.

Generally, in network based mobility management, a proxy (or a proxy function) is inserted between the MR function of the DMF and the MNs. It is noted that the DMF and its associated architecture as presented herein may apply to both host based and network based mobility management. FIG. 4b illustrates a logical view of a communications system 450 where network based mobility management is used. As discussed earlier, communications system 450 includes proxies (such as proxy 410) positioned between a DMF (such as DMF 455) and MNs. The proxies may be located in an access router, which may be referred to as a mobile access gateway defined in proxy.

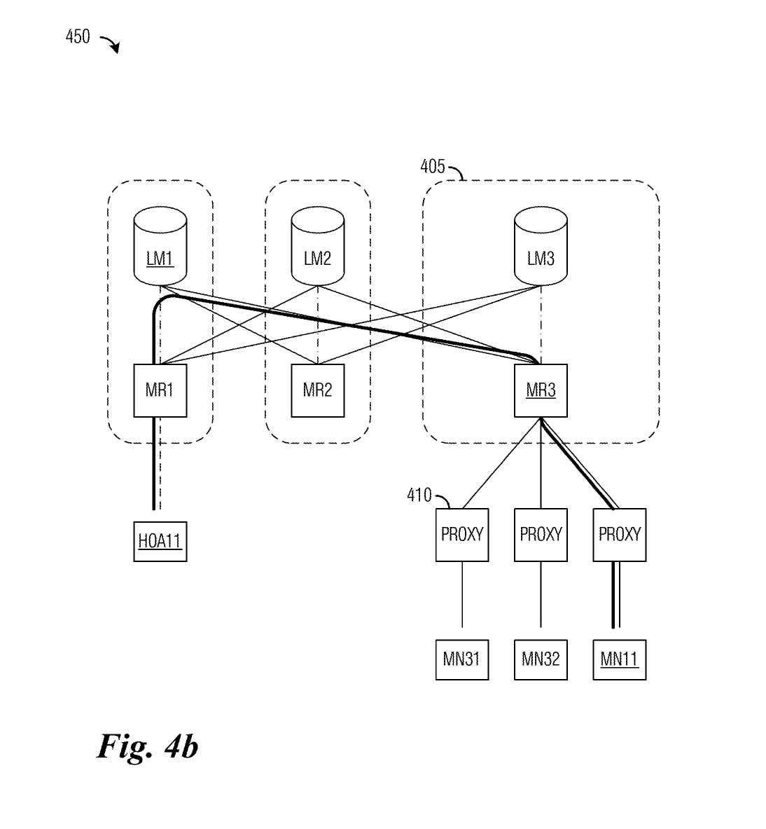

FIG. 5 illustrates a logical view of a communications system with decomposition of a route. In general, a route between a CN 505 and a MN 510 in a communications system utilizing distributed mobility management may be decomposed into three distinct routing segments. A first routing segment 515 comprises a routing segment between CN 505 and a MR 520 of a network associated with a DMF 525. A second segment 530 comprises a routing segment between MR 520 and MR 535 of a network associated with a DMF 540. A third segment 545 comprises a routing segment between MR 535 and MN 510. Utilizing the example embodiments described herein, multiple different distributed mobility management designs may be implemented.

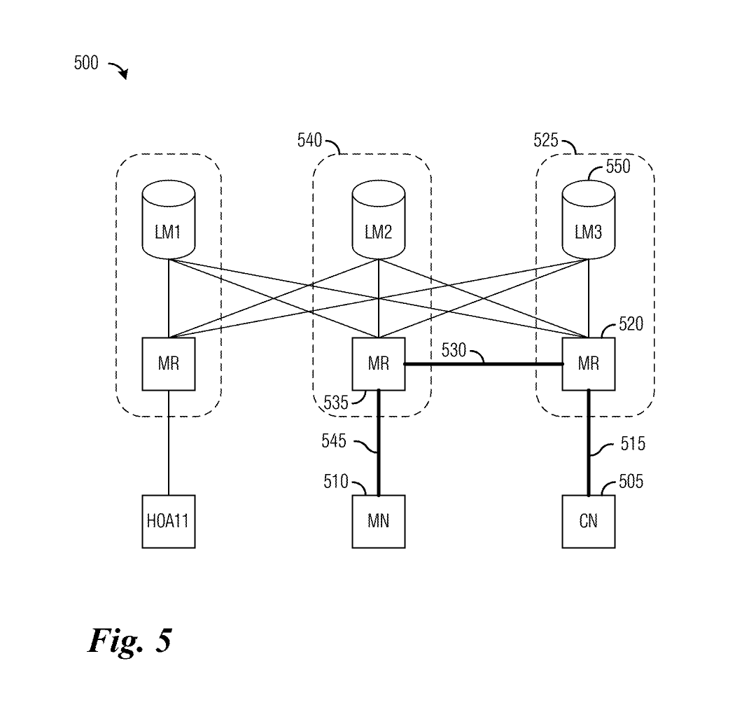

As an example, for first routing segment 515 an anycast routing technique may be used to route packets to MR 520 (the anycast routing technique is referred to herein as RS1-1). As used herein, the anycast routing technique operates by having MR 520 include the HoA of MN 510 in its route announcements as if each MR is the destination for the HoA. The route announcements may affect a routing table so that packets destined for the HoA will be routed to MR 520. FIG. 6a illustrates a flow diagram of operations 600 in RS1-1 at an MR. Referencing back now to FIG. 5, as another example, for first routing segment 515, MR 520 may be located in a device to which packets will always pass (the location of an MR in a device to which packets will always pass is referred to herein as RS1-2). Examples of such devices include a gateway router of the network associated with DMF 525 or an access router of the network associated with DMF 525. FIG. 6b illustrates a flow diagram of operations 650 in RS1-2 at an MR.

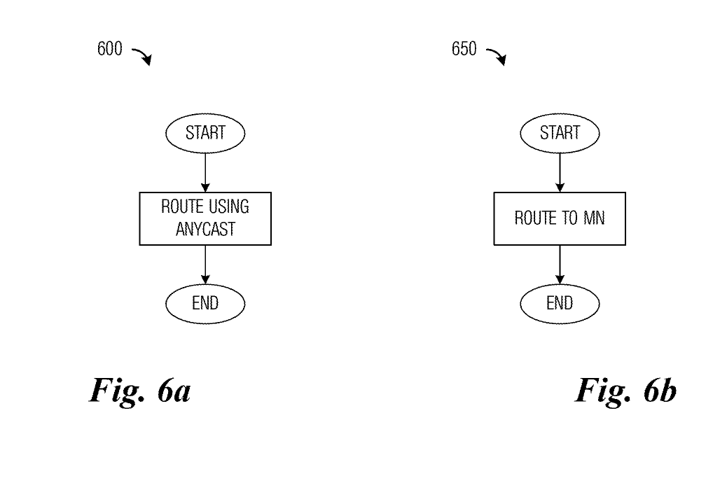

Referencing back now to FIG. 5, as an example, for second routing segment 530 a query to the location database may be used, with the resulting information being used to establish a tunnel to tunnel packets to MR 535 (the query to the location database is referred to herein as RS2-1). A delay (associated with querying the location database and establishing the tunnel) may be incurred. However, the results (the information from the query as well as the tunnel) may be saved for subsequent use. Alternatively, until the reply to the query is received, the first packets may initially be sent to the HN. FIG. 7a illustrates a flow diagram of operations 700 in RS2-1 at an MR. Referencing back now to FIG. 5, as another example, for second routing segment 530 a first packet to the home network of MN 510 may be performed using MIP or proxy MIP mechanisms (using a MIP or a proxy MIP is referred to herein as RS2-2). The first packet may be intercepted by MR 520, which may use the location database to determine the current location of MN 510 and use the mapping in the location database to tunnel the packet to MR 535. MR 535 may inform DMF 525 (the DMF of CN 505) to tunnel subsequent packets directly to MR 535. MR 535 may either DMF 525 by either informing MR 520 or by sending information to LM 550. In either situation, the information becomes available to MR 520, which may maintain the information in its own memory for use in routing subsequent packets. FIG. 7b illustrates a flow diagram of operations 750 in RS2-2 at an MR.

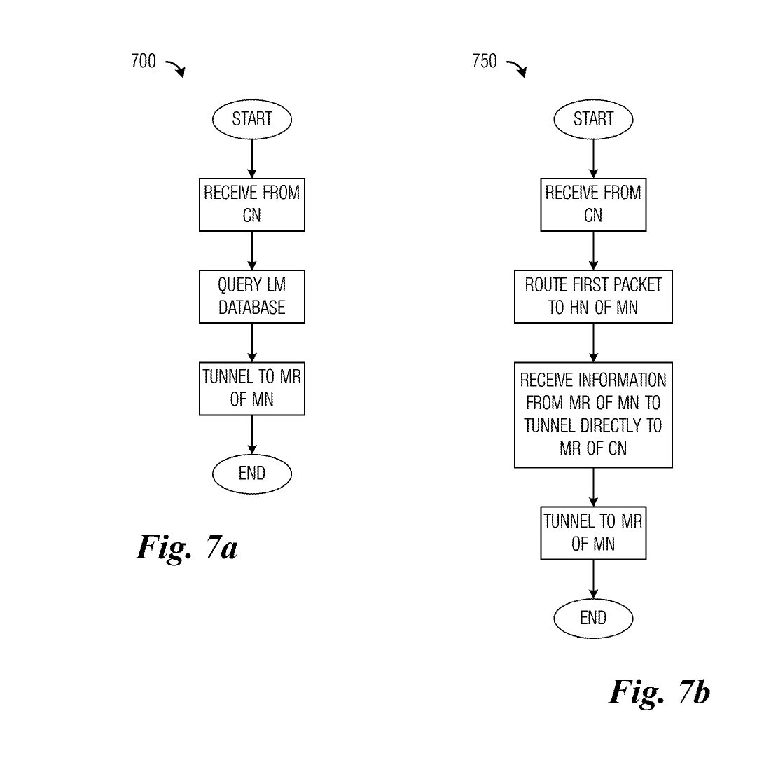

Referencing back now to FIG. 5, as an example, for third routing segment 545 MR 535 may keep track of the location of MN 510 and route packets to MN 510 using an intra-network mobility management mechanism (the use of an intra-network mobility management mechanism is referred to herein as RS3-1). FIG. 8 illustrates a flow diagram of operations 800 in RS3-1 at an MR.

Referencing back now to FIG. 5, it is noted that any selection of the above listed examples for a routing segment may be used in combination with any selection of the above listed examples for another routing segment. As an illustrative example, the selection of either anycast routing (RS1-1), location of the MR (RS1-2), and the like, for first routing segment 515 may be independent of the selection of location database querying (RS2-1), first packet routing to home network (RS2-2), and the like, for second routing segment 530. In general, due to the distributed nature of distributed mobility management, it does not matter how a packet gets to a MR. Therefore, the routing technique selected for each routing segment may be selected independently (as well as operate independently) of one another.

As another illustrative example, for second routing segment 530, RS2-1 makes use of a query to the location database, whereas RS2-2 does not. In a generalized design of a location database, the location database system may support the database query regardless of the use of either RS2-1 or RS2-2. In RS2-1, the database query may be initiated by MR 520. Therefore, the LM of the home network of MN 510 may only need to support the database query and the MR of the home network is not involved. Hence, whether the home network uses RS2-1 or RS2-2, MR 520 may use RS2-1. Therefore, for second routing segment 530, if the home network uses RS2-2 while MR 520 uses RS2-1, MR 520 has already received information needed to tunnel the first packet to the network associated with DMF 540 after querying the home network without concern given to the home network using RS2-2.

As another illustrative example, for second routing segment 530, if the MR of the home network uses RS2-1 while MR 520 uses RS2-2, the MR of the home network may be expecting MR 520 to query the location database. However, due to its use of RS2-2, MR 520 does not perform the query. Instead, MR 520 forwards the first packet to the home network, which is intercepted by the MR of the home network. The network of CN 505 may expect the home network to forward the packet to MN 510 in the network associated with DMF 540 (i.e., the visited network) and to inform MR 520 of an optimized route to the visited network. In RS2-1, the MR of the home network does not inform MR 520 of the optimized route on its own, which may lead to all subsequent packets being routed to MN 510 via the home network. It is noted that this is standard practice for centralized mobility management. However, in distributed mobility management, the MR of the home network may treat the receipt of the first packet as a database query and send information about the location of MN 510 to MR 520 or the LM 550. Therefore, the network of CN 505 has the information about MN 510 in the visited network. MR 520 is therefore able to tunnel subsequent packets to the visited network.

According to an example embodiment, a communications system may have a subset of networks implementing distributed mobility management and a subset of networks implementing centralized mobility management. As an example, when a CN in a network implementing distributed mobility management sends a packet to a MN in a network implementing centralized mobility management, it may attempt to query a location database of the home network of the MN, but it may not receive an answer. However, the MR of the CN may still forward packets to the home network using existing MIP mechanisms.

The example embodiments disclosed herein provides support for dynamic mobility management. When a MN is operating in its home network, there may not be a need to provide inter-network mobility management because local mobility management within the home network is sufficient. As described previously, the LM of the home network may maintain a binding of the HoA of the MN to an address of an MR of a visited network only when the MN has moved to the visited network.

When the MN has moved to the visited network, the MN may have two addresses (or prefixes), the HoA and the CoA, that it may use depending on the needs of particular applications. As an example, some applications, such as applications that have already started in a previous network using the HoA prior to the MN performing a handover to the visited network, require the use of the HoA. In order to preserve session continuity, the MN may need to continue using the HoA in the visited network. As another example, some applications, such as if the MN is using a dynamic prefix and starts a new application after completing the handover to the visited network, may not require the use of the HoA. The MN may use the CoA to set up a new session in such a situation and the HoA is not used. Therefore, the home network is not involved in providing mobility support. The home network may also need to determine whether or not the MN needs mobility support. If the MN does not need mobility support but the home network does not know it, the home network may waste resources in providing such unneeded support.

Once ongoing sessions (or applications) of the MN using the HoA has completed, the MN may deregister with the LM of the home network, allowing the LM of the home network to remove the binding of the HoA to the MR of the visited network. The MN may then make use of the CoA for future sessions.

According to an example embodiment, when the MN is using a dynamic address (or prefix), an address (or prefix) allocation process of the home network may communicate with or co-locate with the LM of the home network. The address (or prefix) allocation process may allocate an address (or prefix) with a finite time span (or lease), and when the lease expires, the LM may remove the binding of the HoA to the MR of the visited network. The HoA is therefore no longer used by the MN and may be allocated to other MNs.

According to an example embodiment, it may be possible that there are ongoing applications (or sessions) using the HoA of the MN in the visited network after the lease expires. Therefore, it may be necessary for the MN to renew the lease of the HoA although the MN has moved to the visited network. Using a host based mobility management system, the MN may request a renewal of the HoA by the home network. With a network based mobility management system, a proxy may perform the mobility signaling to request the renewal of the HoA on behalf of the MN, while also serving as a proxy between the MN and the home network. In other words, the proxy will perform the renewal of the HoA on behalf of the MN.

According to an example embodiment, it may be a novel behavior for a network entity in a visited network to renew a lease on an address (or prefix) allocated in a home network. Alternatively, the MR of the home network may also serve as a proxy between the MN or the MR of the visited network and the address (or prefix) allocation process of the home network. In such a situation, the address (or prefix) allocation process may receive a message regarding lease renewal from the home network.

In a typical deployment, a communications system comprises a mix of networks with differing capability. Some networks may support distributed mobility management, while others may support centralized mobility management. Therefore, there will be communications involving a mix of different networks. As an example, one network may possess distributed mobility management so it supports distributed mobility (this network will be referred to as a D-network), another network may not possess distributed mobility management and are legacy networks supporting centralized mobility management (this network will be referred to as a C-network).

Different possible combinations are to be supported:

D-network to D-network communications: A node in a D-network may communicate with another node in another D-network. Both can take full advantage of distributed mobility management;

D-network to C-network communications: A node in a D-network may communicate with another node in a C-network. The C-network supports only centralized mobility management, therefore, the D-network must also support centralized mobility management so that the communications between the nodes can take place; and

C-network to C-network communications: A node in a C-network may communicate with another node in another C-network. Both can utilize centralized mobility management.

As described previously, one technique of distributed mobility management for the routing of a first packet from a CN to a MN involves routing the first packet to a MR of the CN according to a distributed mobility management technique (e.g., RS 1-1 or RS1-2) selected for the first routing segment between the CN and the MR of the CN. If the MN has moved away from its home network to a visited network, but the MR of the CN does not know that the MN has moved to the visited network. The MR of the CN may therefore send the first packet to the home network of the MN, which means that the first packet will arrive at the MR of the home network. If the home network is a D-network and the MN has moved to the visited network, then the MR of the home network may need to know whether or not the network of the CN (i.e., a sender network) is a D-network or a C-network (i.e., if the sender network uses distributed mobility management). With this knowledge, the MR of the home network may signal the MR of the sender network to set up a distributed mobility route.

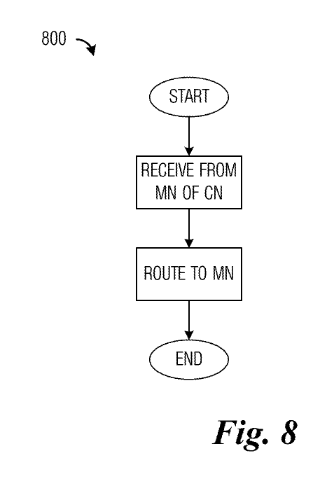

FIG. 9 illustrates a flow diagram of operations 900 in communications between two networks of a communications system. Operations 900 may be indicative of operations occurring in a sender network and/or a receiver network as the two networks communicate.

Operations 900 may begin with a first MR of a first network determines the capability and/or an address of a second MR of the second network (block 905). The first MR may utilize a variety of techniques to determine the capability and/or the address of the second MR. Example techniques are discussed in detail below. Utilizing the address of the second MR, the first MR and the second MR may establish a mechanism for distributed mobility communications (block 910). As an example, the first MR and the second MR may exchange messages to establish the routing segments, such as a first routing segment, a second routing segment, and/or a third routing segment as described previously, for example, needed to route packets between a CN and a MN.

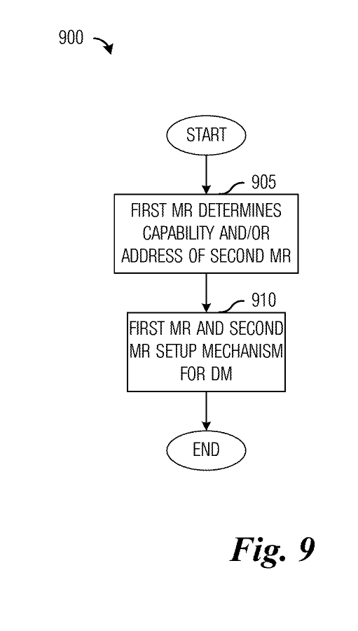

FIG. 10 illustrates a flow diagram of operations 1000 in communications between two networks of a communications system in accordance with a first example embodiment. Operations 1000 may be indicative of operations occurring in a communications system in accordance with the first example embodiment.

Operations 1000 may begin with the MR of a first network, e.g., a sender network, registering with a location database so that other networks may discover its distributed mobility management capability (block 1005). With the MR of the first network being registered in the location database, a MR of a second network, such as a MR of a receiver network (i.e., a home network of a MN), may be able to determine the address of the MR of the first network (block 1010). Hence, when a node from the second network sends a packet to a node in the first network, the MR of the first network may query the location database to determine if the second network possesses a MR, i.e., the second network is distributed mobility management capable. The MRs of the first network and the second network may perform signaling to perform distributed mobility management (block 1015). In other words, the MRs of the first network and the second network may setup a mechanism for distributed mobility management.

According to an example embodiment, the registration may be based on address prefix (e.g., IP address) ranges of the network. A sender network may be responsible for a range(s) of address prefixes that are used to allocate prefixes and/or addresses to nodes attached to it. When a packet from a sender network arrives at a receiver network (which happens to be a D-network) the MR of the receiver network may check the address prefix and/or address and query the location database using the sender's prefix and/or address. If the MR of the sender network has registered with the location database, the location database may provide the prefix and/or address of the MR of the sender network. Then the MR in the receiver network may communicate with the MR in the sender network to set up the mechanism for distributed mobility management.

According to an example embodiment, the location database may use a commonly available location database, such as domain name system (DNS) database. It may be simpler to use a commonly available database to add new database entries to form a location database and to query the location database since the addition of a new database is not required.

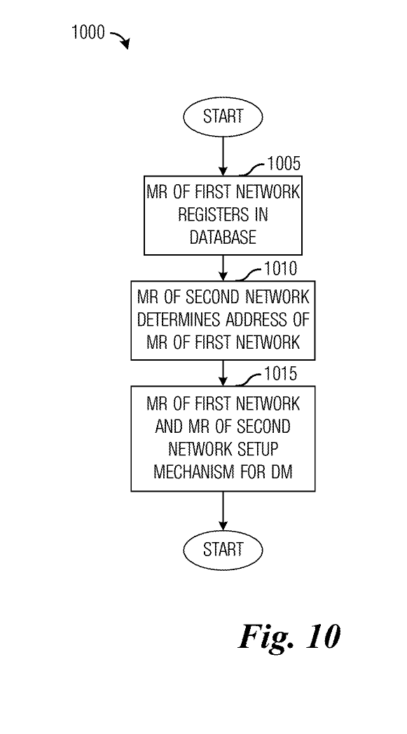

FIG. 11 illustrates a flow diagram of operations 1100 in communications between two networks of a communications system in accordance with a second example embodiment. Operations 1100 may be indicative of operations occurring in a communications system in accordance with the second example embodiment.

According to the second example embodiment, a first packet destined for a MN (in a first network) from the CN (in a second network) may be routed to the MR of the CN in accordance with a technique selected for first routing segment RS 1. However, the MN has moved from its home network to a visited network, but the MR of the CN does not know this. Therefore, the MR of the CN may send the first packet to the home network, which means that the MR of the home network (also the first network) will receive the first packet. The MR of the home network may examine the first packet to determine the prefix and/or address of the CN (block 1105). However, the MR of the home network does not know the prefix and/or address of the MR of the CN.

The MR of the home network may send a control packet to the prefix of the first packet (block 1110). As an example, the control packet may be addressed to a non-existent node in the second network. In other words, the control packet may be addressed to a special address designated for a non-existent node. The MR of the CN may receive the packet (block 1115). The MR of the home network and the MR of the CN may perform signaling to perform distributed mobility management (block 1120).

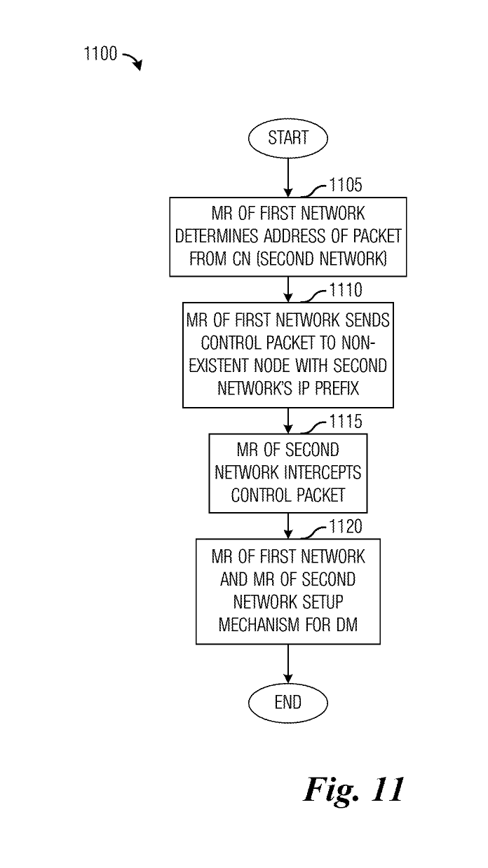

FIG. 12 illustrates a flow diagram of operations 1200 in communications between two networks of a communications system in accordance with a third example embodiment. Operations 1200 may be indicative of operations occurring in a communications system in accordance with the third example embodiment.

According to the third example embodiment, a first packet from the CN (in a first network) destined for a MN (in a second network) may be routed to the MR of the CN in accordance with a technique selected for first routing segment RS 1. However, the MN has moved from its home network to a visited network, but the MR of the CN does not know this. The MR of the CN may send the first packet to the home network (block 1205). The first packet may be marked with an indicator that the network of the CN (the first network) is a D-network. The first packet may also include an address of the MR of the CN. The MR of the MN may process the first packet (block 1210). In the processing of the first packet, the MR of the MN may be able to determine that the first network is a D-network (from the indicator) and the address of the MR of the CN (from the address of the MR of the CN included in the first packet). The MR of the home network and the MR of the CN may perform signaling to perform distributed mobility management (block 1215).

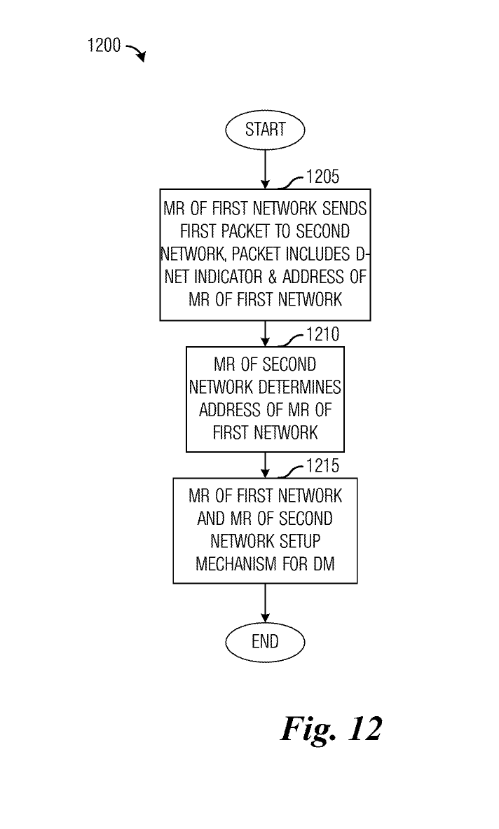

FIG. 13 illustrates a flow diagram of operations 1300 in communications between two networks of a communications system in accordance with a fourth example embodiment. Operations 1300 may be indicative of operations occurring in a communications system in accordance with the fourth example embodiment.

In general, the location database may be distributed with a server in each network of the communications system. The location database and a prefix and/or address allocation function may be co-located or may be able to communicate with each other. Typically, the prefix and/or address allocation function assigns a globally unique prefix and/or address to a node in a corresponding network. The prefix and/or address allocation function may be configured to assign prefixes and/or addresses within a specified prefix and/or address range. The location database may know the different prefix and/or address ranges for each of the networks in the communications system.

Operations 1300 may begin with a partitioning of an address space and assigning of different ranges to different networks (block 1305). According to the fourth example embodiment, each network is assigned a disjoint range of prefixes and/or addresses, so that no two networks may assign prefixes and/or addresses that overlap. Since the prefixes and/or addresses are disjoint, when a MR of a home network or a MR of a CN receives a first packet, it may be able to determine the MR (or its address) responsible for routing the first packet (block 1310). As an example, the MR of the home network or the MR of the CN may access the location database to perform a reverse lookup in accordance with an address of the first packet to determine the MR (or its address) that is routing the first packet. The MR of the home network or the MR of the CN may perform signaling with the MR that is routing the first packet to perform distributed mobility management (block 1315).

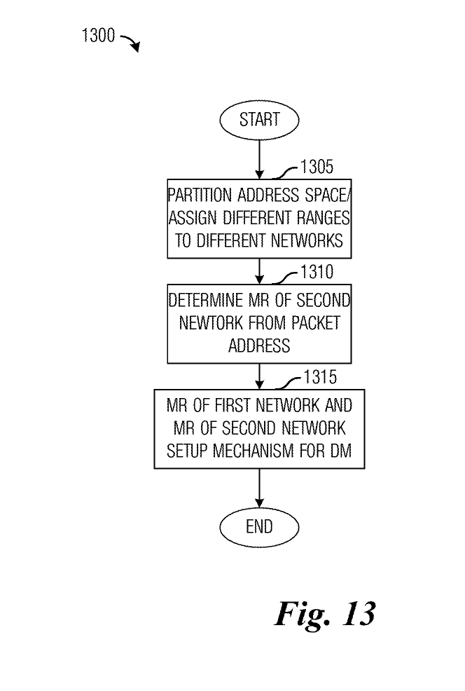

FIG. 14 illustrates a flow diagram of operations 1400 in communications between two networks of a communications system in accordance with a fifth example embodiment. Operations 1400 may be indicative of operations occurring in a communications system in accordance with the fifth example embodiment.

Operations 1400 may begin with a MR of a first network (e.g., the network of the CN) accessing a location database to determine an address of a MR of the MN which is located in a second network (block 1405). The location database may provide the MR of the first network with the address of the MR of the second network where the MN is currently located. The MR of the first network and the MR of the second network may perform signaling to perform distributed mobility management (block 1410).

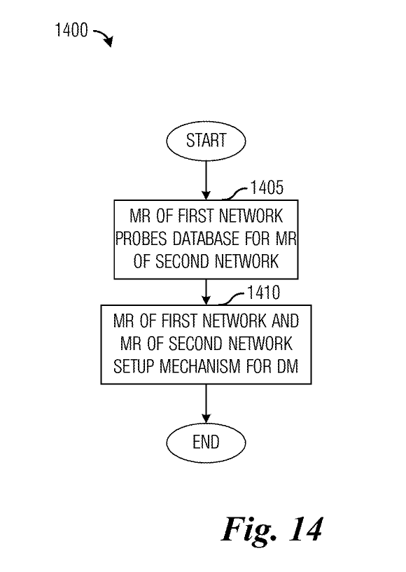

FIG. 15 illustrates a flow diagram of operations 1500 in communications between two networks of a communications system in accordance with a sixth example embodiment. Operations 1500 may be indicative of operations occurring in a communications system in accordance with the sixth example embodiment.

Operations 1500 may begin with the MR of a first network (e.g., the home network of the MN) sending location information regarding the MN to a location database of the MN (located in a second network). The MR of the first network may use the location database to provide the location information. The MR of the first network may achieve this by accessing the location database for the MR of the second network (block 1505). The MR of the first network and the MR of the second network may perform signaling to perform distributed mobility management (block 1510).

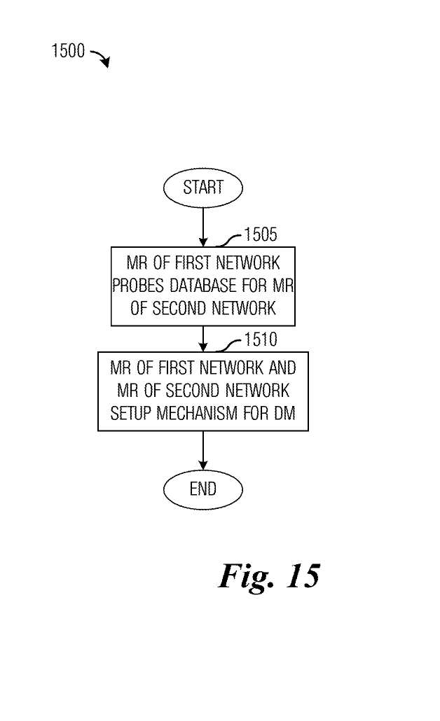

FIG. 16 provides an illustration of a first communications device 1600. Communications device 1600 may be an implementation of a network entity, such as a gateway router, an access router, and the like, with DMF. Communications device 1600 may be used to implement various ones of the embodiments discussed herein. As shown in FIG. 16, a transmitter 1605 is configured to send packets and/or signals and a receiver 1610 is configured to receive packets and/or signals. Transmitter 1605 and receiver 1610 may have a wireless interface, a wireline interface, or a combination thereof.

An address allocating unit 1620 is configured to allocate a prefix or an address, such as a HoA, for a node attached to a network containing communications device 1600. As an example, address allocating unit 1620 may assign an initial HoA to a node when it first attaches to the network, which is referred to as a home network for the node. A location managing unit 1622 is configured to manage and keep track of the node as the node moves, potentially changing networks and/or exiting the communications system all together. Location managing unit 1622 is configured to manage a location database for the network and establishes an entry for the node when the node moves away from its home network. A mobility routing unit 1624 is configured to intercept packets address to the mode's HoA or originating from the node's HoA and forward the packets to their intended destination. A memory 1630 is configured to store addresses, prefixes, address ranges, prefix ranges, packets, location information, location database, and so on.

The elements of communications device 1600 may be implemented as specific hardware logic blocks. In an alternative, the elements of communications device 1600 may be implemented as software executing in a processor, controller, application specific integrated circuit, or so on. In yet another alternative, the elements of communications device 1600 may be implemented as a combination of software and/or hardware.

As an example, transmitter 1605 and receiver 1610 may be implemented as a specific hardware block, while address allocating unit 1620, location managing unit 1622, and mobility routing unit 1624 may be software modules executing in a processor 1615, a microprocessor, a custom circuit, or a custom compiled logic array of a field programmable logic array. Address allocating unit 1620, location managing unit 1622, and mobility routing unit 1624 may be stored as modules in memory 1630.

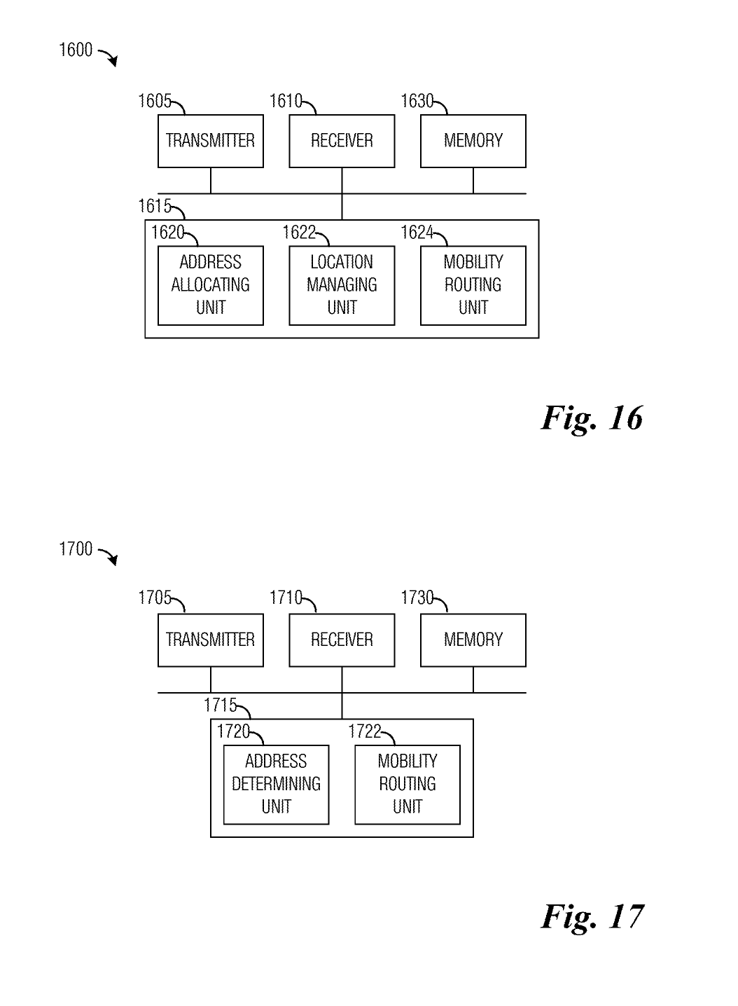

FIG. 17 provides an illustration of a second communications device 1700. Communications device 1700 may be an implementation of a network entity, such as a gateway router, an access router, and the like, with DMF. Communications device 1700 may be used to implement various ones of the embodiments discussed herein. As shown in FIG. 17, a transmitter 1705 is configured to send packets and/or signals and a receiver 1710 is configured to receive packets and/or signals. Transmitter 1705 and receiver 1710 may have a wireless interface, a wireline interface, or a combination thereof.

An address determining unit 1720 is configured to determine an address or prefix for a network entity, such as a MR of a network. Address determining unit 1720 may determine addresses and/or prefixes using a variety of techniques, including accessing a location database, processing a received packet, using address ranges and/or prefix ranges, and the like. A mobility routing unit 1722 is configured to perform signaling with another entity in the communications system to establish a mobility routing mechanism. A memory 1730 is configured to store addresses, prefixes, address ranges, prefix ranges, packets, location information, location database, and so on.

The elements of communications device 1700 may be implemented as specific hardware logic blocks. In an alternative, the elements of communications device 1700 may be implemented as software executing in a processor, controller, application specific integrated circuit, or so on. In yet another alternative, the elements of communications device 1700 may be implemented as a combination of software and/or hardware.

As an example, transmitter 1705 and receiver 1710 may be implemented as a specific hardware block, while address determining unit 1720 and mobility routing unit 1722 may be software modules executing in a processor 1715, a microprocessor, a custom circuit, or a custom compiled logic array of a field programmable logic array. Address determining unit 1720, and mobility routing unit 1722 may be stored as modules in memory 1730.

Although the present disclosure and its advantages have been described in detail, it should be understood that various changes, substitutions and alterations can be made herein without departing from the spirit and scope of the disclosure as defined by the appended claims.

What is claimed is:

1. A method for operating a network device, the method comprising:
receiving, by the network device, a packet addressed to a first mobile node at a first initial home address when the first mobile node is outside a home network;
accessing, by the network device, a location database to determine a current network for the first mobile node; and
routing, by the network device, the packet to the first mobile node in the current network.

2. The method of claim 1, wherein the first initial home address is assigned to the first mobile node when the first mobile node initially attached to the home network.

3. The method of claim 1, wherein accessing the location database comprises retrieving an address of a first mobility router in the current network.

4. The method of claim 3, further comprising updating the location database with an address of a second mobility router of a new network.

5. The method of claim 3, further comprising routing the packet to the first mobility router in the current network.

6. The method of claim 1, wherein accessing the location database comprises retrieving an address of a first access router in the current network.

7. The method of claim 1, further comprising updating the location database with a new network of the first mobile node.

8. The method of claim 7, wherein updating the location database occurs after the first mobile node handovers to the new network.

9. A method for routing a packet from a first device to a second device, the method comprising:
determining, by a first mobility router of the first device, a first address of a second mobility router of the second device; and
setting up, by the first mobility router, a mechanism for distributed routing with the second mobility router in accordance with the first address of the second mobility router.

10. The method of claim 9, wherein determining the first address of the second mobility router comprises accessing a location database to determine the first address of the second mobility router.

11. The method of claim 9, wherein determining the first address of the second mobility router comprises:
determining a first source address of a first packet from the second device; and
transmitting a control packet to a second address having a common address prefix as the first source address of the first packet.

12. The method of claim 9, wherein determining the first address of the second mobility router comprises:
receiving a second packet including addressing information from the second mobility router; and
determining the first address of the second mobility router from the addressing information.

13. The method of claim 9, wherein determining the first address of the second mobility router comprises:
determining an address range of the second device in accordance with a second source address of a third packet received from the second device; and
identifying the second mobility router in accordance with the address range.

14. A network device comprising:
a receiver configured to receive a packet addressed to a first mobile node at a first initial home address when the first mobile node is outside a home network; and
a processor operatively coupled to the receiver, the processor configured to access a location database to determine a current network for the first mobile node, and to route the packet to the first mobile node in the current network.

15. The network device of claim 14, wherein the processor is configured to retrieve an address of a first mobility router in the current network.

16. The network device of claim 15, wherein the processor is configured to route the packet to the first mobility router in the current network.

17. The network device of claim 14, wherein the processor is configured to retrieve an address of a first access router in the current network.

18. The network device of claim 14, wherein the processor is configured to update the location database with an address of a second mobility router of a new network.

19. The network device of claim 14, wherein the processor is configured to perform an attachment procedure with a second mobile node, and to assign a second initial home address to the second mobile node.

20. A first mobility router comprising:
a processor configured to determine a first address of a second mobility router of a second device, and to set up a mechanism for distributed routing with the second mobility router in accordance with the first address of the second mobility router.

21. The first mobility router of claim 20, wherein the processor is configured to access a location database to determine the first address of the second mobility router.

22. The first mobility router of claim 20, wherein the processor is configured to determine a first source address of a first packet from the second device, and wherein the first mobility router further comprises a transmitter operatively coupled to the processor, the transmitter configured to transmit a control packet to a second address having a common address prefix as the first source address of the first packet.

23. The first mobility router of claim 20, further comprising a receiver operatively coupled to the processor, the receiver configured to receive a second packet including addressing information from the second mobility router, and wherein the processor is configured to determine the first address of the second mobility router from the addressing information.

24. The first mobility router of claim 20, wherein the processor is configured to determine an address range of the second device in accordance with a second source address of a third packet received from the second device, and to identify the second mobility router in accordance with the address range.
